(19) United States
(12) Patent Application Publication
(10) Pub. No.: US 2026/0023861 A1
(43) Pub. Date: Jan. 22, 2026

(54) Detection of malicious code by forcing execution violation

(71) Applicant: Palo Alto Networks (Israel Analytics) Ltd., Tel Aviv (IL)

(72) Inventors: Eldar Aharoni, Holon (IL); Eli Birkan, Tel Aviv (IL); Or Chechik, Rishon LeZion (IL); Jon Doron, Herzliya (IL); Bar Lahav, Herzliya (IL)

(21) Appl. No.: 18/779,134

(22) Filed: Jul. 22, 2024

(51) Int. Cl. G06F 21/57; G06F 9/50

(52) U.S. Cl. CPC G06F 21/577; G06F 9/5016

(57) ABSTRACT

A method for detecting malicious code, including, in a computer, intercepting a call to an operating-system (OS) function, the call requesting an execution privilege for a memory region. In response to intercepting the call, the execution privilege requested by the call is removed. Upon detecting an exception that occurs due to an executable code in the memory region starting to run without the execution privilege, a check is made for determining whether the executable code in the memory region is malicious or benign.

### TECHNICAL FIELD

Embodiments described herein relate generally to protection of computing devices from security threats, and particularly to methods and systems for detecting malicious code in memory.

### BACKGROUND

In many computers such as endpoint computers in an organization, multiple layers of security apparatus and software are deployed to detect and repel the ever-growing range of security threats. At the most basic level, computers typically use antivirus software to prevent malicious software from running on the computer.

The description above is presented as a general overview of related art in this field and should not be construed as an admission that any of the information it contains constitutes prior art against the present patent application.

### SUMMARY

An embodiment that is described herein provides a method for detecting malicious code, including, in a computer, intercepting a call to an operating-system (OS) function, the call requesting an execution privilege for a memory region. In response to intercepting the call, the execution privilege requested by the call is removed. Upon detecting an exception that occurs due to an executable code in the memory region starting to run without the execution privilege, a check is made for determining whether the executable code in the memory region is malicious or benign.

In some embodiments, the OS function includes a memory allocation function that allocates the memory region, or a memory access control function that controls access privileges of the memory region. In other embodiments, the OS function includes an application programming interface (API) memory management function that calls a corresponding OS memory management function. In yet other embodiments, intercepting the call includes calling a callback handler that depending on a source of the call handles (i) removal of the execution privilege and (ii) checking of the executable code in the memory region.

In an embodiment, calling the callback handler includes registering the callback handler to an instrumentation callback feature of the OS that passes control to the callback handler upon intercepting the call and upon detecting the exception. In another embodiment, calling the callback handler includes hooking the OS function to the callback handler, and passing control to the callback handler upon intercepting the call. In yet another embodiment, calling the callback handler includes hooking to the callback handler an exception handler that is called when the exception occurs, and passing control to the callback handler via the exception handler upon detecting the exception.

In some embodiments, the OS function includes an intermediate OS function in an intermediate processing layer that mediates between 32-bit processing and 64-bit processing. In other embodiments, the executable code in the memory region includes a shellcode that is not mapped to any file in a disk of the computer. In yet other embodiments, the executable code in the memory region includes code that was loaded to the memory region from a disk of the computer.

In an embodiment, checking whether the executable code in the memory region is malicious or benign includes checking one or more portions of the executable code using one or both of (i) code checking rules, and (ii) behavioral threat protection (BTP) rules.

There is additionally provided, in accordance with an embodiment that is described herein, a computer that includes a memory and a processor. The memory includes a memory region. The processor is configured to intercept a call to an operating-system (OS) function, the call requesting an execution privilege for a memory region, in response to intercepting the call, to remove the execution privilege requested by the call, and upon detecting an exception that occurs due to an executable code in the memory region starting to run without the execution privilege, to check whether the executable code in the memory region is malicious or benign.

These and other embodiments will be more fully understood from the following detailed description of the embodiments thereof, taken together with the drawings in which:

### BRIEF DESCRIPTION OF THE DRAWINGS

FIG. 1 is a block diagram that schematically illustrates a computing device supporting detection of malicious code in memory, in accordance with an embodiment that is described herein;

FIG. 2 is a flow chart that schematically illustrates a method for detecting malicious code in memory by forcing execution violation, in accordance with an embodiment that is described herein;

FIGS. 3A-3C are diagrams that schematically illustrate example hooking and callback techniques that are applicable in implementing the method of FIG. 2, in accordance with embodiments that are described herein; and

FIG. 4 is a diagram that schematically illustrates interactions between malware that stores a malicious shellcode in memory, and a shellcode handler that detects the malicious shellcode by forcing execution violation, in accordance with an embodiment that is described herein.

### DETAILED DESCRIPTION OF EMBODIMENTS

### Overview

Embodiments that are described herein provide methods and systems for protecting against execution of malicious code (e.g., a malicious shellcode). To this end, execution violation is forced by removing an execution privilege of the virtual memory region in which the code resides, before the code starts running. The execution violation allows to check whether the detected code is malicious or benign, and to respond accordingly.

An organization (e.g., a company) typically comprises multiple computing devices (e.g., computers) that are interconnected, e.g., via a local area network (LAN). Such a computing device is also referred to as an “endpoint device”, “endpoint computer” or simply “endpoint”, for brevity. A local security operations center (SOC) is typically also coupled to the LAN, and is used for handling visualization, analysis and responding to cybersecurity threats. The endpoints typically have access to a remote security server, e.g., over the Internet.

The endpoints of the organization may be subjected to various types of cybersecurity attacks and threats such as, for example, advanced malware, exploits, fileless attacks, ransomware attacks, persistence attacks, and backdoor attacks.

For example, an attacker may attempt to steal from an endpoint passwords and other sensitive information, apply injection methods, communicate with an attacking server, exploit vulnerabilities of the endpoint, and the like.

Some cybersecurity attacks on endpoints are carried out by malicious code in memory such as (but not limited to) shellcodes. In the present context, a shellcode is an executable code that is not mapped to any file on the disk of the endpoint computer. Since antivirus programs typically scan the disk of the endpoint in search of malicious programs, a shellcode that resides in the virtual memory of process but not on the disk is hard to detect.

A shellcode may be written into the virtual memory of a process running on the endpoint, for example, by a malware that successfully evaded detection by the underlying antivirus program. The malware may contain a packed shellcode that is unpacked during the malware execution. In this case, the malware on the disk hides the malicious shellcode and is therefore hard to detect by the antivirus program. As another example, the shellcode may be written to the virtual memory and run when the endpoint has a vulnerability. In this case, the vulnerability (e.g., exposed while surfing the Internet using a browser) enables the attacker to run the shellcode. In another type of attack, a malicious shellcode may inject itself into another process, e.g., for gaining higher access privileges and/or for running from a more sensitive process, and the like.

In general, malicious code other than a shellcode may be loaded from a file on the disk and executed, e.g., when the file successfully evades detection by the antivirus program.

To mitigate cybersecurity attacks, the endpoint may run an endpoint protection agent that monitors various events occurring in the endpoint such as, for example, the processes running, file read/write operations from/to the disk, accessing IP addresses, behavioral aspects of the events over time, e.g., using a behavioral threat protection (BTP) engine, and the like. Based on the monitored events, the endpoint protection agent can detect malicious activities (e.g., malicious code in memory) that result in generating corresponding alerts. Upon detecting malicious activity (or a sequence of activities that together create a malicious attack) the endpoint protection agent typically applies a responsive action to block or otherwise mitigate the malicious activity. In some embodiments, the agent sends alerts (and/or incidents comprising one or more alerts) to the remote security server, which can detect and mitigate attacks using more complex schemes than can be carried out at the endpoint level.

To run a malicious code (or a malicious shellcode), a malware typically allocates a memory region for the code in the virtual memory of the process being attacked and assigns to the memory region an execution privilege. The malware additionally writes the malicious code (or shellcode) to the allocated memory region and starts running the malicious code.

In principle, the endpoint could detect malicious code (or shellcode) in memory by repeatedly scanning the virtual memory of the processes running on the endpoint, for identifying suspicious executable code. This memory scanning approach, however, incurs significant endpoint computing resources. Moreover, with memory scanning, a malicious code or shellcode may be detected long after it has started to run, which may be too late for preventing significant damage caused by that malicious code. The attacker may later run over the malicious code or delete it from memory, to avoid detection.

In the disclosed embodiments, a memory region contains an executable code that may be malicious. An execution violation is forced by removing an execution privilege of the memory region before the executable code starts running, thereby allowing the endpoint to check whether the executable code is malicious or benign.

Consider a method, including, in a computer, intercepting a call to an operating-system (OS) function, the call requesting an execution privilege for a memory region. In response to intercepting the call, the execution privilege requested by the call is removed. Upon detecting an exception that occurs due to an executable code in the memory region starting to run without the execution privilege, a check is made for determining whether the executable code in the memory region is malicious or benign.

In some embodiments, the OS function comprises a memory allocation function that allocates the memory region, or a memory access control function that controls access privileges of the memory region. The OS function may comprise an application programming interface (API) memory management function that calls a corresponding os memory management function.

In an embodiment, in intercepting the call, a callback handler is called, that depending on a source of the call handles (i) removal of the execution privilege and (ii) checking of the executable code in the memory region. In one embodiment, calling the callback handler comprises registering the callback handler to an instrumentation callback feature of the OS that passes control to the callback handler upon intercepting the call and upon detecting the exception. In another embodiment, calling the callback handler comprises hooking the OS function to the callback handler, and passing control to the callback handler upon intercepting the call. In yet another embodiment, calling the callback handler comprises hooking to the callback handler an exception handler that is called when the exception occurs, and passing control to the callback handler via the exception handler upon detecting the exception.

In some embodiments, the OS function comprises an intermediate OS function in an intermediate processing layer that mediates between 32-bit processing and 64-bit processing.

In some embodiments, the executable code in the memory region comprises a shellcode that is not mapped to any file in a disk of the computer. In other embodiments, the executable code in the memory region comprises code that was loaded to the memory region from a disk of the computer.

In an embodiment, checking whether the executable code in the memory region is malicious or benign (upon detecting the exception) comprises checking one or more portions of the executable code using one or both of (i) code checking rules, and (ii) behavioral threat protection (BTP) rules.

In the disclosed techniques, calls to memory management functions that request an execution privilege to a memory region are intercepted. The execution privilege is removed so that when the code starts running an execution exception occurs, thereby allowing to check whether the code is malicious or benign. Using the disclosed techniques allows to detect malicious code in memory, promptly and efficiently, without the need to scan the memory. Moreover, the disclosed embodiments incur very little processing resources and power consumption.

### System Description

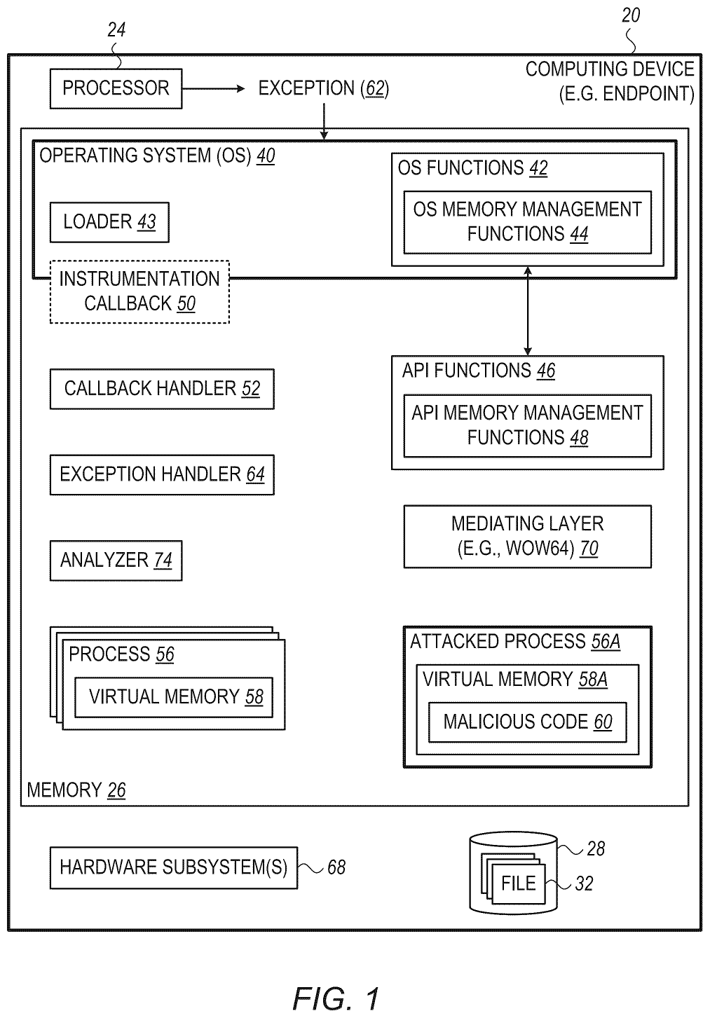

FIG. 1 is a block diagram that schematically illustrates a computing device 20 supporting the detection of malicious code in memory, in accordance with an embodiment that is described herein. In the configuration shown in FIG. 1, computing device 20 comprises a processor 24, a memory 26 and a storage device 28.

In an embodiment described herein, processor 24 and memory 26 in computing device 20 are coupled to storage device 28 that stores files 32. In some embodiments, computing device 20 may comprise a controller (e.g., implemented using a hardware subsystem 68 that is described below) such as Serial AT Attachment (SATA) or Serial-Attached SCSI (SAS) that connects the computing device to storage device 28. In other embodiments, storage device 28 may be in a network attached storage (NAS) system or in a storage area network (SAN) that is coupled to computing device 20 via a network connection (e.g., using a hardware subsystem 68 that is described below).

In the example of FIG. 1, memory 26 comprises an operating system (OS) 40 and other elements that will be described below. In the description that follows OS 40 refers mainly to the WINDOWS™ operating system, produced by Microsoft Corporation, Redmond, Washington, USA. The WINDOWS™ OS is, however, given by way of example, and other suitable OSs (e.g., Linux) can also be used. In some embodiments, OS 40 runs in kernel mode, whereas code in memory 26 outside the OS runs in user mode. Code running in user mode can call certain OS functions indirectly, by calling corresponding application programming interface (API) functions.

OS 40 comprises OS functions 42 and a loader 43. Some of OS functions 42 provide various system-related services, e.g., memory management services provided by OS memory management functions 44. At least some of OS functions 42 are associated with corresponding API functions 46. For example, OS memory management functions 44 are associated with corresponding API memory management functions 48. As such, a call to an API memory management function 48 results in calling the corresponding OS memory management function 44.

In an embodiment, API memory management functions 48 may include, for example, a memory allocation function and a memory access control function, each of which receiving as arguments the address and size of a memory region in the virtual memory of the underlying process, and one or more of Read/Write/Execution (R/W/X) privileges. In WINDOWS™, an example API memory allocation function is the VirtualAlloc function, and an example API memory access control function is the VirtualProtect function, which are both implemented in a dynamic link “kernel32.dll”. The OS memory library referred to as functions corresponding to the VirtualAlloc and VirtualProtect functions are the NtProtectVirtualMemory and NtAllocateVirtualMemory, which are implemented in a dynamic link library referred to as “Ntdll.dll.

In some embodiments, with the WINDOWST OS, memory management functions (44) that are intercepted by the instrumentation callback feature may include the following functions:
NtAllocateVirtualMemory.
Nt FreeVirtualMemory.
NtProtectVirtualMemory
NtMapViewOfSection
NtUnmapViewOfSection
NtAllocateVirtualMemoryEx
NtMapViewOfSectionEx
NtUnmapViewOfSectionEx

Each of OS memory management functions (44) listed above has a corresponding API memory management function (48).

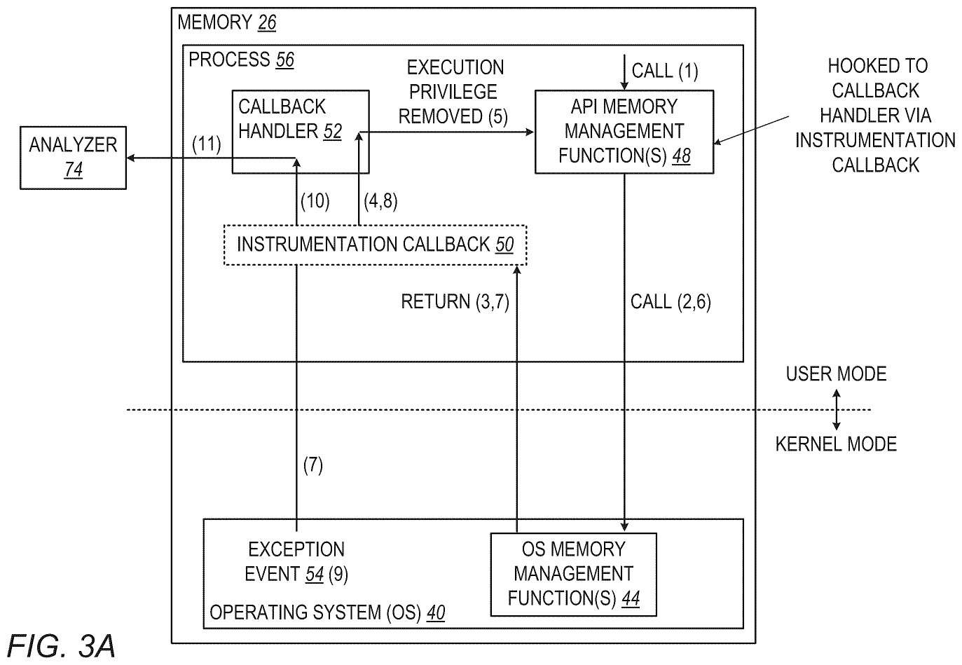

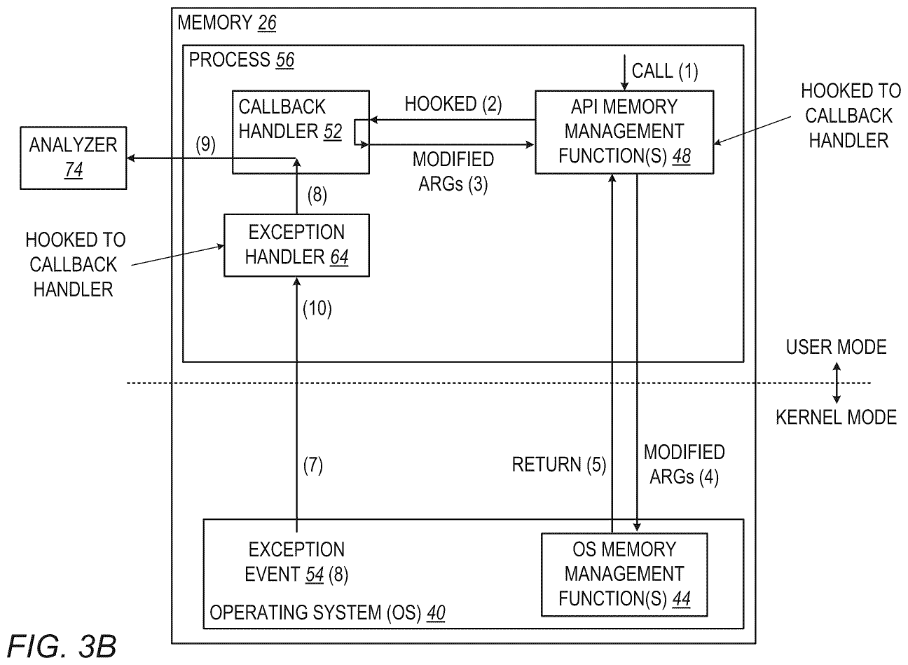

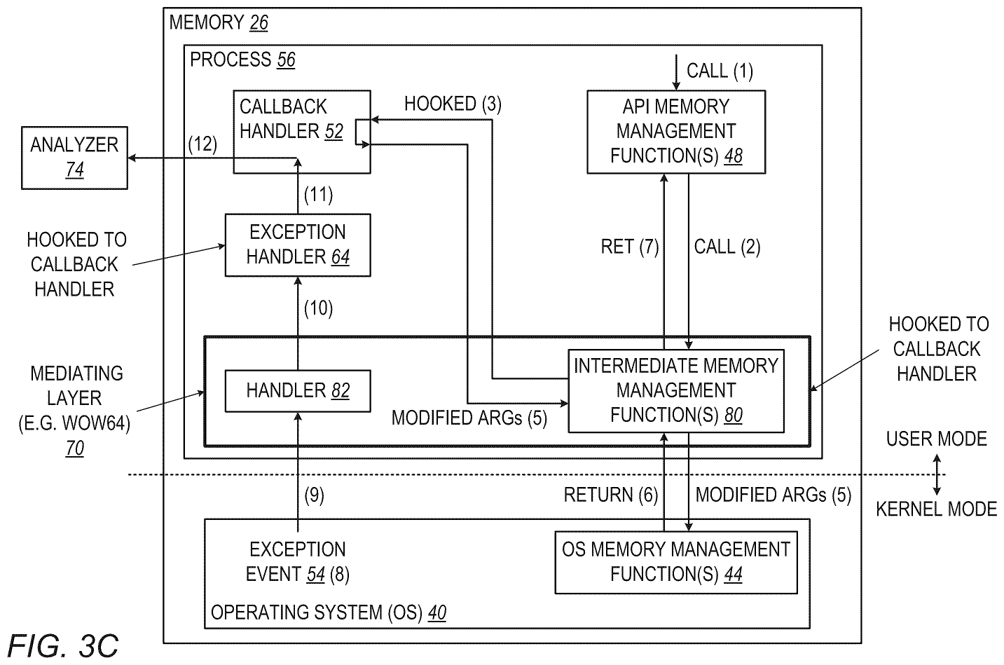

In some embodiments, OS 40 further comprises an instrumentation callback feature 50, which is used for intercepting calls to API functions 46 running in user mode, which in turn call corresponding OS functions 42 running in kernel mode. Upon returning from kernel mode to user mode, a callback handler 52 that was registered to the instrumentation callback beforehand is called. Moreover, when using the instrumentation callback feature, the callback handler is also called when an exception event 54 (e.g., an execution exception) occurs. An example usage of the instrumentation callback feature will be described in detail with reference to FIG. 3A below.

Memory 26 further comprises one or more processes 56, each of which has an allocated virtual memory 58. In some embodiments, OS 40 uses loader 43 for loading a file 32 from storage device 28 to a virtual memory 58 of a process 56. For example, a file 32 may comprise an executable code, and the file is loaded to the virtual memory for running the code of the file.

Each process 56 (and 56A) may run respective process code (not shown) to carry out the tasks of the process. Among other operations, the process may call API functions 46 such as API memory management functions 48.

In attacked process 56A, a malicious code 60 may perform an attack only when the virtual memory region 58A in which it resided has been assigned an execution privilege. Otherwise, upon attempting to run code in a virtual memory region whose exception privilege is turned off, execution violation occurs, which triggers an exception event 54.

In the embodiments described above, calls to the API memory management functions 48 as well as exception events 54 are intercepted via the instrumentation callback feature, which results in calling callback 52. In other embodiments, certain API memory handler management functions 48 are hooked to the callback handler, and exception events result in calling an exception handler 64. Hooking and callback methods of this sort will be described in detail with reference to FIGS. 3B and 3C below. In the WINDOWS™ OS, exception handler 64 may comprise an exception dispatcher referred to as “KiUserExceptionDispatcher”.

When called because of calling an API memory management function 48 that requests an execution privilege for a virtual memory region, the callback handler removes the execution privilege so as to force an execution violation if any code starts to run in the memory region. Upon an exception due to running code in the memory region without the exception privilege, the callback handler or exception handler 64 takes a responsive action, e.g., checking whether the code that caused the execution violation is malicious or benign. In some embodiments, checking the code is carried out by checking one or more portions of the code. The portions of a shellcode are sometimes referred to as “shellcode buffers”.

Memory 26 further comprises a mediating layer 70 that mediates between different processing units. In WINDOWS™, layer 70 mediates between 32-bit and 64-bit processing and is referred to as a (Windows 32-bit on Windows 64-bit (WOW64) layer. The purpose of the mediating layer is to enable running applications written for 32-bit processing, using a 64-bit processor. Hooking techniques that involve layer 70 will be described with reference to FIG. 3C below.

In some embodiments computing device 20 may comprise one or more hardware subsystems 68. For example, a given hardware subsystem 68 may comprise an Input/Output (I/O) device such as a network controller for accessing the underlying LAN and/or the Internet. As another example, a hardware subsystem 68 may comprise a storage controller for accessing storage device 28.

In some embodiments, memory 26 comprises an analyzer 74, configured to check whether code in a virtual memory region of a process is malicious or benign. Analyzer 74 may perform an out of process examination.

The configuration of computing device 20 of FIG. 1 is given by way of example, and other suitable computing device configurations can also be used. In an embodiment, processor 24 comprises a general-purpose central processing unit (CPU) or one or more special-purpose embedded processors, which are programmed in software or firmware to carry out the functions described herein. This software may be downloaded to computing device 20 in electronic form, over for example, a network, Additionally or alternatively, the software may be stored on tangible, non-transitory computer-readable media, such as optical, magnetic, or electronic memory media. Further additionally or alternatively, at least some of the functions of processor 24 may be carried out by hard-wired or programmable digital logic circuits.

Examples of memory 26 and storage device 28 include dynamic random-access memories, non-volatile random-access memories, hard disk drives and solid-state disk drives.

In some embodiments, tasks described herein performed by processor 24 may be split among multiple physical and/or virtual computing devices. In other embodiments, at least some of these tasks may be performed in a managed cloud service.

### Methods for Detecting Malicious Code in Memory

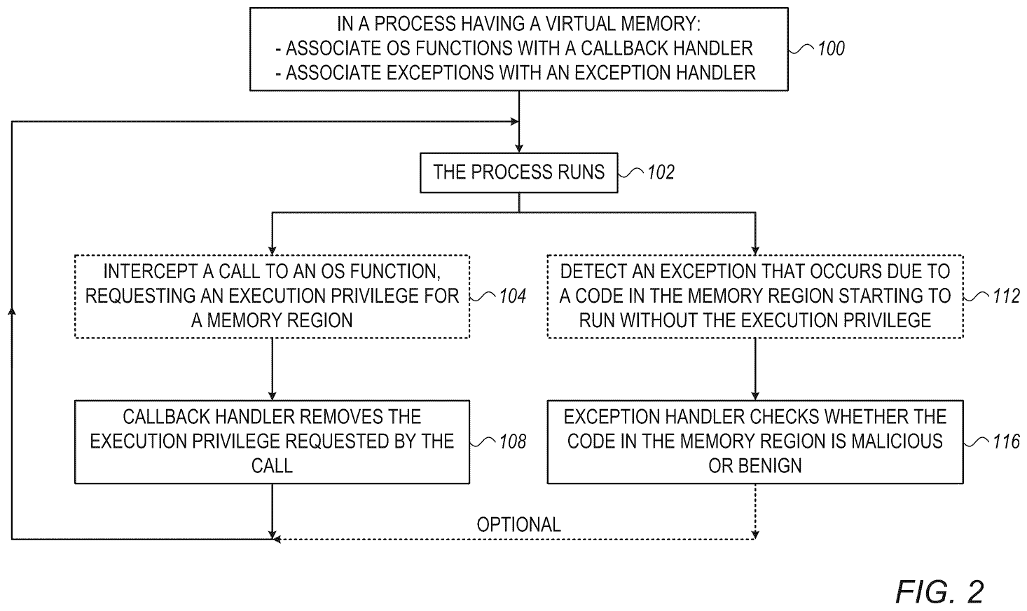

FIG. 2 is a flow chart that schematically illustrates a method for detecting malicious code in memory by forcing execution violation, in accordance with an embodiment that is described herein.

The method will be described as executed by elements of computing device (e.g., endpoint) 20.

First are explained terms and phrases related to hooking and callback techniques. In the present context, the term “hooked function” or “hooked feature” refers to a function or a feature that is pre-associated with some “callback function”. The phrase “intercepting a call” means that upon calling a hooked function (or triggering the hooked feature), the callback function will be called. Similarly, the phrase “intercepting an exception” means that when an exception is triggered by the callback function or another preassigned processor, a exception handler will be called. Methods for hooking and callback will be described further below.

In describing the method of FIG. 2, process 56A may be attacked by malicious code 60.

The method of FIG. 2 begins at a hooking step 100, with processor 24 running a process 56A (to be attacked), the process has a virtual memory 58A. The method (i) associating between at least some of OS functions 42 and callback handler 52, and (ii) associating between exceptions 54 occurring while running the process, and exception handler 64. In an embodiment, the exception handler may be implemented within the callback handler. As will be described further below, the OS functions hooked at step 100 may comprise API memory management functions 48 that in turn call corresponding OS memory management functions 44. Alternatively, the hooked OS functions may comprise the OS memory management functions 44 themselves. In both cases, the hooked memory management functions comprise memory allocation functions that are used for allocating virtual memory (and assigning requested access privileges), and memory access control functions that control access privileges to allocated memory regions.

At a running step 102, processor 24 runs the process (56A) to perform the tasks of that process.

At a call interception step 104, a call to a hooked OS memory management function (or to a hooked API memory management function) is intercepted, the call requesting an execution privilege for a memory region in the virtual memory (58A) of the process (56A). The intercepted call may be initiated for example, by a malware in the virtual memory of the process, the malware aiming to run malicious code (60) in the memory region. Since the intercepted OS or API memory management function is hooked, control is now passed to callback handler 52.

At an execution privilege removal step 108, in response to intercepting the call at step 104, processor 24 runs callback handler 52 to remove the execution privilege of the virtual memory region (58A), therefore forcing execution violation when code in the memory region (e.g., malicious code 60) will start running. Following step 108, control is passed back to the process (56A), and the method loops back to step 102 to continue running the process.

At an exception detection step 112, processor 24 triggers an exception (54) that occurs due to code in the virtual memory region (58A) starts running without the execution privilege (that has been intentionally removed at step 108). The code may comprise malicious code 60 written to the virtual memory region 58A, e.g., by a malware, or loaded from a file 32 in storage device 28. In response to the triggered exception, control is passed to exception handler 64.

At an exception handling step 116, processor 24 runs exception handler 64 to check whether the code in the virtual memory region (58A) is malicious or benign. To this end, processor 24 may call analyzer process 74 that analyzes the content of the virtual memory region (58A) in question. Alternatively or additionally, the analyzer can decide whether the code is malicious or benign by applying to the relevant memory region (or to part thereof) behavioral threat protection (BTP) rules.

Depending on the analysis results, control is passed from the exception handler back to the process (56A) to the code that was interrupted by the exception, or elsewhere. In an example embodiment, when at step 116 the code in virtual memory 58A is found to be malicious (malicious code 60), the processor may kill the attacked process (56A) to prevent the malicious code from causing damage. Alternatively, when the code in the virtual memory (56A) is found to be benign, the method may loop back to step 102 to continue running the process 56A.

The method of FIG. 2 is given by way of example, and other suitable methods can also be used. For example, although at step 100 OS functions are hooked to the callback handler, in other embodiments the callback handler may be registered for hooking instrumentation call back feature 50. In such embodiments, the functionality of exception handler 64 may be implemented within callback handler 52. The instrumentation callback feature will be described in detail with reference to FIG. 3A below.

### Example Hooking and Callback Techniques

FIGS. 3A-3C are diagrams that schematically illustrate example hooking and callback techniques that are applicable in implementing the method of FIG. 2, in accordance with embodiments that are described herein.

In FIG. 3A, callback and exception handling are implemented using instrumentation callback feature 50. As noted above, when the callback handler is pre-registered for hooking the instrumentation callback feature, processor 24 passes control to the callback handler function upon returning from kernel mode to user mode, and upon an exception 54 being triggered. The callback handler may be registered to the instrumentation callback feature beforehand (e.g., at initialization step 100 of the method of FIG. 2). In some disclosed embodiments, the hooked instrumentation callback feature is used for intercepting calls to API functions 46 running in user mode, which in turn call corresponding OS functions 42 running in kernel mode.

The processing chain occurring upon calling an API memory management function is now described. Upon calling an API memory management function 48 (1), that API memory management function calls a corresponding OS memory management function 44 (2), which causes the processor to switch from user mode to kernel mode. When OS memory function 44 returns (3), the processor switches back from kernel mode to user mode, which due to the hooked instrumentation callback 50 passes control to the callback handler (4). It is noted that at this point, the OS memory management function that was called at (2) is already executed and therefore may have set an execution privilege to a memory region in the virtual memory of the underlying process.

The callback handler identifies that it was called due to calling an API memory management function 48, and in response, calls an API memory access control function 48 with the execution privilege of the memory region removed (5). As a result, the API memory access control function 48 calls a corresponding OS memory access control function 44 (6) and upon return (7) the instrumentation callback feature passes control to callback handler 52 again (8). In some embodiments, the callback handler sets a flag (e.g., in a thread context) before calling the API memory access control function (5) to avoid recursive calling. Following the second call to the callback handler (8), control is passed back to the process, to the callback handler. in this case control is passed back to code within the callback handler, which was the last code executed.

At this point, the execution privilege for the virtual memory region has been removed, and therefore execution of code (e.g., malicious code 60) from this memory region will trigger an execution exception (9). Next, due to instrumentation callback feature 50, control is passed to the callback handler (10). The callback handler identified that it was called due to an exception, and in response, calls analyzer 74 (11) so as to check whether the code that started running in the memory region without the execution privilege is malicious or benign, as described above.

In FIG. 3B, callback and exception handling are implemented by hooking certain API memory management functions 48 and exception handler 64 to callback handler 52. Such hooking may be carried out, for example, by replacing the first bytes of the API management functions and of the exception handler with a jump instruction to callback handler 52. This hooking method is sometimes referred to as “inline hooking”. In an alternative hooking method, pointers used for calling the API management functions and the exception handler may be replaced with a pointer to callback handler 52. Hooking the API management functions and the exception handler to the callback handler, as described above, may be done beforehand (e.g., at initialization step 100 of the method of FIG. 2).

The processing chain occurring upon calling an API memory management function 48 is now described. Upon calling a hooked API memory management function 48 (1), that API memory management function calls callback handler 52 (2), which modifies the arguments to the API memory management function and returns control to the calling API management function (3). In some embodiments, the callback handler identifies that an argument of the API memory management function requests an execution privilege to the memory region, and in response modifies this argument to remove the execution privilege. The API memory management function calls the corresponding OS memory management function with the execution privilege removed (4) and returns to the user mode (5).

At this point, the execution privilege for the memory region has been removed, and therefore execution of code (e.g., malicious code 60) from this memory region will trigger an exception event 54 (6). Next, due to the hooking of the exception handler, control is passed (7) to callback handler 52 (8). The callback handler identifies that it was called due to an exception, and in response, calls analyzer 74 (9) to check whether the code in the memory region is malicious or benign, as described above.

The chain of operations in FIG. 3C is similar to that of FIG. 3B. In FIG. 3C, however, mediating layer 70 (e.g., the WOW64 layer of WINDOWS™) includes (i) intermediate memory management function(s) 80 mediating between API memory management functions 48 and OS memory management functions 44, and (ii) a hander 82 that upon exception event 54 passes control to exception handler 64, which is hooked to callback handler 52.

It is noted that the mediating layer is omitted from FIGS. 3A and 3B for the sake of simplicity and clarity, and because it has no impact on the hooking and callback flows.

The hooking method in FIG. 3C is similar to that of FIG. 3B, but in FIG. 3C, instead of hooking API memory management functions 48, corresponding intermediate memory management functions are hooked to the callback handler. In addition, upon an exception event, handler 82 passes control to exception handler 64 (10) and further via exception handler 64 to callback handler 52 (10). Hooking the WOW64 functions may be advantages over hooking the API functions because such hooking better addresses compatibility issues with other security software or with self-extracting code (packers). In the present context, compatibility issues means that some software that is installed on the endpoint, such as (but not limited to) other security software, may also hook code in processes, which may often lead to unexpected scenarios and may cause crashes.

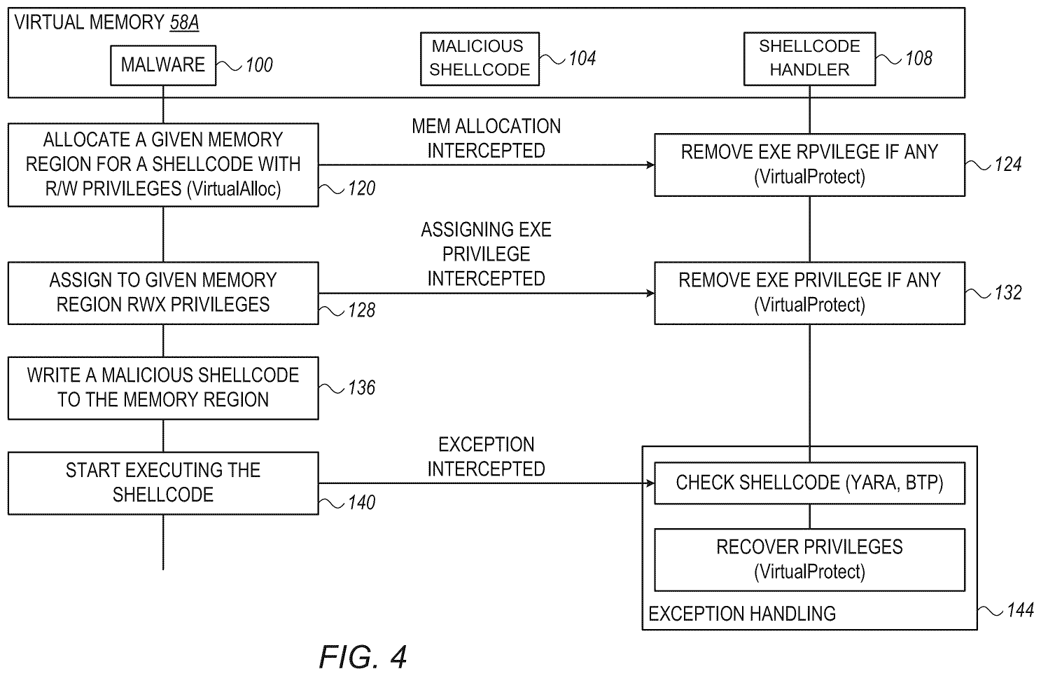

FIG. 4 is a diagram that schematically illustrates interactions between malware 100 that stores a malicious shellcode 104 in memory, and a shellcode handler 108 that detects the malicious shellcode by forcing execution violation, in accordance with an embodiment that is described herein.

Malware 100, malicious shellcode 104 and shellcode handler 108 may reside in virtual memory 58A of attacked process 56A, in which case malicious code 60 of FIG. 1 comprises malicious shellcode 104 of FIG. 4. Shellcode handler 108 may be implemented, for example, using the functionality of callback handler 52.

The diagram of FIG. 4 starts with malware 100 allocating a given memory region in virtual memory 58A, at a memory allocation step 120. In the present example the malware allocates the memory region using the API memory management function VirtualAlloc with the access control arguments set to provide Read/Write (R/W) privileges. In response to intercepting the call to the VirtualAlloc function, since the allocated virtual memory 58A does not have an execution privilege, shellcode handler 108 skips removing the execution privilege of the allocated memory region, at a privilege removal step 124. In an alternative embodiment, if at step 120 the privileges set are R/W/X, the shellcode removes the execution privilege X.

At an execution privilege assignment step 128, malware 100 assigns an execution privilege to the memory region allocated, e.g., by calling the API memory management function VirtualProtect with R/W/X privileges. Due to intercepting the call to the VirtualProtect function, the shellcode handler is called, and removes the execution privilege X that was set by the malware, at a second removal step 132.

At a shellcode writing step 136, malware 100 writes malicious code 104 to the memory region, and at a running step 140, the malware runs the malicious shellcode in virtual memory 58A. Since the execution privilege has been removed by the shellcode handler, an execution violation occurs, which triggers an exception 54, which results in calling callback handler 52.

The callback handler identifies it was called due to an exception event, and in response takes a responsive action, at an exception handling step 144. In an example embodiment, the callback handler (or exception handler) applies analyzer 74 to analyze the shellcode using YARA rules to identify the detected shellcode. If the shellcode matches one or more of the YARA rules, the analyzer may further apply BTP rules to decide whether the shellcode is malicious or benign.

At step 144, the analyzer may further recover the original access privileges of the memory region and thus allow the shellcode to continue running. In one embodiment, the shellcode is allowed to run only when the analyzer determines that the shellcode is benign. In another embodiment, the shellcode is allowed to run in parallel to checking the shellcode. In this case, if the analyzer decides that the shellcode is malicious, the analyzer may kill the process (e.g., kill the entire relevant process tree) to block the malicious shellcode.

The diagram of FIG. 4 is given by way of example, and other suitable diagrams can also be used. In a variant diagram, malware 100 writes the shellcode (step 136) after allocating the memory region (step 120) and before assigning the R/W/X privileges (step 128). In another variant diagram, the malware allocates the memory region (step 120) with an execution privilege. In this case, steps 128 and 132 may be omitted.

The embodiments described above are given by way of example, and other suitable embodiments can also be used. For example, although FIG. 4 refers mainly to mitigating a malicious shellcode, the steps carried out by the shellcode handler may be similarly applied to other malicious code that is mapped to an executable file 32 in storage device 28. For example, such an executable file may comprise a backed page-file on the storage device that is mapped in the virtual memory as executable.

In some embodiments, the malicious code comprises a self-extracting shellcode. This means that when the shellcode in the virtual memory runs, it writes a decoded shellcode to the same memory region. In such embodiments, after restoring the R/W/X privileges and allowing the shellcode to run, the processor assigns to the memory region R/X privileges to cause a write access exception when the shellcode attempts to write the decoded shellcode to the same memory region. In addition, after intercepting or catching the write exception, the exception callback handler restores the W privilege and removes the X privilege so as to intercept the event of the decoded shellcode starts running.

Although the diagram in FIG. 4 refers to mitigating a malicious shellcode, the steps applied by the shellcode handler may be similarly applied for mitigating malicious code other than a shellcode.

Although the embodiments described herein mainly address detection of malicious code by forcing execution violation, the methods and systems described herein can also be used in other applications, such as in Sandbox environments, or for debugging and instrumentation use cases. It will be appreciated that the embodiments described above are cited by way of example, and that the following claims are not limited to what has been particularly shown and described hereinabove. Rather, the scope includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for detecting malicious code, comprising:
in a computer, intercepting a call to an operating-system (OS) function, the call requesting an execution privilege for a memory region;
in response to intercepting the call, removing the execution privilege requested by the call; and
upon detecting an exception that occurs due to an executable code in the memory region starting to run without the execution privilege, checking whether the executable code in the memory region is malicious or benign.

2. The method according to claim 1, wherein the OS function comprises a memory allocation function that allocates the memory region, or a memory access control function that controls access privileges of the memory region.

3. The method according to claim 1, wherein the OS function comprises an application programming interface (API) memory management function that calls a corresponding OS memory management function.

4. The method according to claim 1, wherein intercepting the call comprises calling a callback handler that depending on a source of the call handles (i) removal of the execution privilege and (ii) checking of the executable code in the memory region.

5. The method according to claim 4, wherein calling the callback handler comprises registering the callback handler to an instrumentation callback feature of the OS that passes control to the callback handler upon intercepting the call and upon detecting the exception.

6. The method according to claim 4, wherein calling the callback handler comprises hooking the OS function to the callback handler, and passing control to the callback handler upon intercepting the call.

7. The method according to claim 4, wherein calling the callback handler comprises hooking to the callback handler an exception handler that is called when the exception occurs, and passing control to the callback handler via the exception handler upon detecting the exception.

8. The method according to claim 1, wherein the OS function comprises an intermediate OS function in an intermediate processing layer that mediates between 32-bit processing and 64-bit processing.

9. The method according to claim 1, wherein the executable code in the memory region comprises a shellcode that is not mapped to any file in a disk of the computer.

10. The method according to claim 1, wherein the executable code in the memory region comprises code that was loaded to the memory region from a disk of the computer.

11. The method according to claim 1, wherein checking whether the executable code in the memory region is malicious or benign comprises checking one or more portions of the executable code using one or both of (i) code checking rules, and (ii) behavioral threat protection (BTP) rules.

12. A computer, comprising:
a memory comprising a memory region; and
a processor, configured to:
intercept a call to an operating-system (OS) function, the call requesting an execution privilege for a memory region;
in response to intercepting the call, remove the execution privilege requested by the call; and
upon detecting an exception that occurs due to an executable code in the memory region starting to run without the execution privilege, check whether the executable code in the memory region is malicious or benign.

13. The computer according to claim 12, wherein the OS function comprises a memory allocation function that allocates the memory region, or a memory access control function that controls access privileges of the memory region.

14. The computer according to claim 12, wherein the OS function comprises an application programming interface (API) memory management function that calls a corresponding OS memory management function.

15. The computer according to claim 12, the processor is configured to intercept the call by calling a callback handler that depending on a source of the call handles (i) removal of the execution privilege and (ii) checking of the executable code in the memory region.

16. The computer according to claim 15, wherein the processor is configured to call the callback handler by registering the callback handler to an instrumentation callback feature of the OS that passes control to the callback handler upon intercepting the call and upon detecting the exception.

17. The computer according to claim 15, wherein the processor is configured to call the callback handler by hooking the OS function to the callback handler, and passing control to the callback handler upon intercepting the call.

18. The computer according to claim 15, wherein the processor is configured to call the callback handler by hooking to the callback handler an exception handler that is called when the exception occurs, and passing control to the callback handler via the exception handler upon detecting the exception.

19. The computer according to claim 12, wherein the OS function comprises an intermediate OS function in an intermediate processing layer that mediates between 32-bit processing and 64-bit processing.

20. The computer according to claim 12, wherein the executable code in the memory region comprises a shellcode that is not mapped to any file in a disk of the computer.

21. The computer according to claim 12, wherein the executable code in the memory region comprises code that was loaded to the memory region from a disk of the computer.

22. The computer according to claim 12, wherein the processor is configured to check whether the executable code in the memory region is malicious or benign by checking one or more portions of the executable code using one or both of (i) code checking rules, and (ii) behavioral threat protection (BTP) rules.
